(19) United States
(12) Patent Application Publication
(10) Pub. No.: US 2025/0070929 A1
(43) Pub. Date: Feb. 27, 2025

(54) TIME-FREQUENCY-ANGULAR RESOURCES

(71) Applicant: QUALCOMM Incorporated, San Diego, CA (US)

(72) Inventors: Stelios STEFANATOS, San Diego, CA (US); Kapil GULATI, Belle Mead, NJ (US); Junyi LI, Greentown, PA (US); Preeti KUMARI, San Diego, CA (US); Shuanshuan WU, San Diego, CA (US)

(21) Appl. No.: 18/845,549

(22) PCT Filed: May 1, 2023
(86) PCT No.: PCT/US2023/020525

§ 371 Date: Sep. 10, 2024

(30) Foreign Application Priority Data
May 27, 2022 (GR) 20220100443

(51) Int. Cl. H04L 5/00; H04W 72/044

(52) U.S. Cl. CPC H04L 5/0023; H04W 72/044

(57) ABSTRACT

Various aspects of the present disclosure generally relate to wireless communication. In some aspects, a first device may select a first time-frequency-angular resource that is identified in a time domain, in a frequency domain, and in an azimuth angle domain. The first device may transmit a first communication using the first time-frequency-angular resource. Numerous other aspects are described.

### CROSS-REFERENCE TO RELATED APPLICATION

This patent application claims priority to Greek Patent Application No. 20220100443, filed on May 27, 2022, entitled “TIME-FREQUENCY-ANGULAR RESOURCES,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for using time-frequency-angular resources.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a first device. The method may include selecting a first time-frequency-angular resource that is identified in a time domain, in a frequency domain, and in an azimuth angle domain. The method may include transmitting a first communication using the first time-frequency-angular resource.

Some aspects described herein relate to a first device for wireless communication. The first device may include a memory and one or more processors coupled to the memory. The one or more processors may be configured to select a first time-frequency-angular resource that is identified in a time domain, in a frequency domain, and in an azimuth angle domain. The one or more processors may be configured to transmit a first communication using the first time-frequency-angular resource.

Some aspects described herein relate to a non-transitory computer-readable medium that stores a set of instructions for wireless communication by a first device. The set of instructions, when executed by one or more processors of the first device, may cause the first device to select a first time-frequency-angular resource that is identified in a time domain, in a frequency domain, and in an azimuth angle domain. The set of instructions, when executed by one or more processors of the first device, may cause the first device to transmit a first communication using the first time-frequency-angular resource.

Some aspects described herein relate to an apparatus for wireless communication. The apparatus may include means for selecting a first time-frequency-angular resource that is identified in a time domain, in a frequency domain, and in an azimuth angle domain. The apparatus may include means for transmitting a first communication using the first time-frequency-angular resource.

Aspects generally include a method, apparatus, system, computer program product, non-transitory computer-readable medium, user equipment, base station, network entity, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network entity in communication with a user equipment (UE) in a wireless network, in accordance with the present disclosure.

FIG. 3 is a diagram illustrating an example of a disaggregated base station, in accordance with the present disclosure.

FIG. 4 is a diagram illustrating an example of sidelink communications, in accordance with the present disclosure.

FIG. 5 is a diagram illustrating an example of sidelink communications and access link communications, in accordance with the present disclosure.

FIG. 6 is a diagram illustrating an example of selecting sidelink resources, in accordance with the present disclosure.

FIG. 7 is a diagram illustrating an example of using beams for communications, in accordance with the present disclosure.

FIG. 8 is a diagram illustrating an example of a frequency-modulated continuous-wave radar, in accordance with the present disclosure.

FIG. 9 is a diagram illustrating examples of radar scanning, in accordance with the present disclosure.

FIG. 10 is a diagram illustrating an example of time-frequency-angular resources, in accordance with the present disclosure.

FIG. 11 is a diagram illustrating an example of using time-frequency-angular resources, in accordance with the present disclosure.

FIG. 12 is a diagram illustrating an example of time-frequency-angular resources, in accordance with the present disclosure.

FIG. 13 is a diagram illustrating an examples of angular resources, in accordance with the present disclosure.

FIG. 14 is a diagram illustrating an example of resource exclusion, in accordance with the present disclosure.

FIG. 15 is a diagram illustrating an example of intersecting and non-intersecting beam directions, in accordance with the present disclosure.

FIG. 16 is a diagram illustrating an example process performed, for example, by a first device, in accordance with the present disclosure.

FIG. 17 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

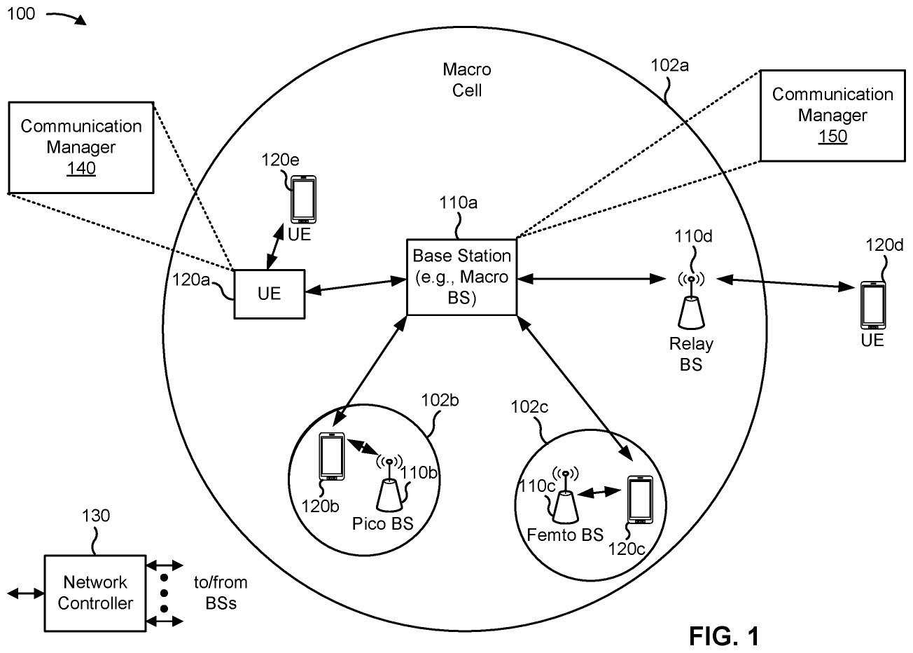

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include a user equipment (UE) 120 or multiple UEs 120 (shown as a UE 120a, a UE 120b, a UE 120c, a UE 120d, and a UE 120c). The wireless network 100 may also include one or more network entities, such as base stations 110 (shown as a BS 110a, a BS 110b, a BS 110c, and a BS 110d), and/or other network entities. A base station 110 is a network entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network entities in the wireless network 100 through various types of backhaul interfaces, such as a direct physical connection or a virtual network, using any suitable transport network.

In some aspects, the term “base station” (e.g., the base station 110) or “network entity” may refer to an aggregated base station, a disaggregated base station, an integrated access and backhaul (IAB) node, a relay node, and/or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network entity” may refer to one device configured to perform one or more functions, such as those described herein in connection with the base station 110. In some aspects, the term “base station” or “network entity” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network entity” may refer to any one or more of those different devices. In some aspects, the term “base station” or “network entity” may refer to one or more virtual base stations and/or one or more virtual base station functions. For example, in some aspects, two or more base station functions may be instantiated on a single device. In some aspects, the term “base station” or “network entity” may refer to one of the base station functions and not another. In this way, a single device may include more than one base station.

The wireless network 100 may include one or more relay stations. A relay station is a network entity that can receive a transmission of data from an upstream station (e.g., a network entity or a UE 120) and send a transmission of the data to a downstream station (e.g., a UE 120 or a network entity). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network with network entities that include different types of BSs, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set network entities and may provide coordination and control for these network entities. The network controller 130 may communicate with the base stations 110 via a backhaul communication link. The network entities may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network entity, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network entity as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FRI (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first device (e.g., a UE 120, a network entity) may include a communication manager 140 or 150. As described in more detail elsewhere herein, the communication manager 140 or 150 may select a first time-frequency-angular resource that is identified in a time domain, in a frequency domain, and in an azimuth angle domain; and transmit a first communication using the first time-frequency-angular resource. Additionally, or alternatively, the communication manager 140 or 150 may perform one or more other operations described herein.

As indicated above, FIG. 1 is provided as an example. Other examples may differ from what is described with regard to FIG. 1.

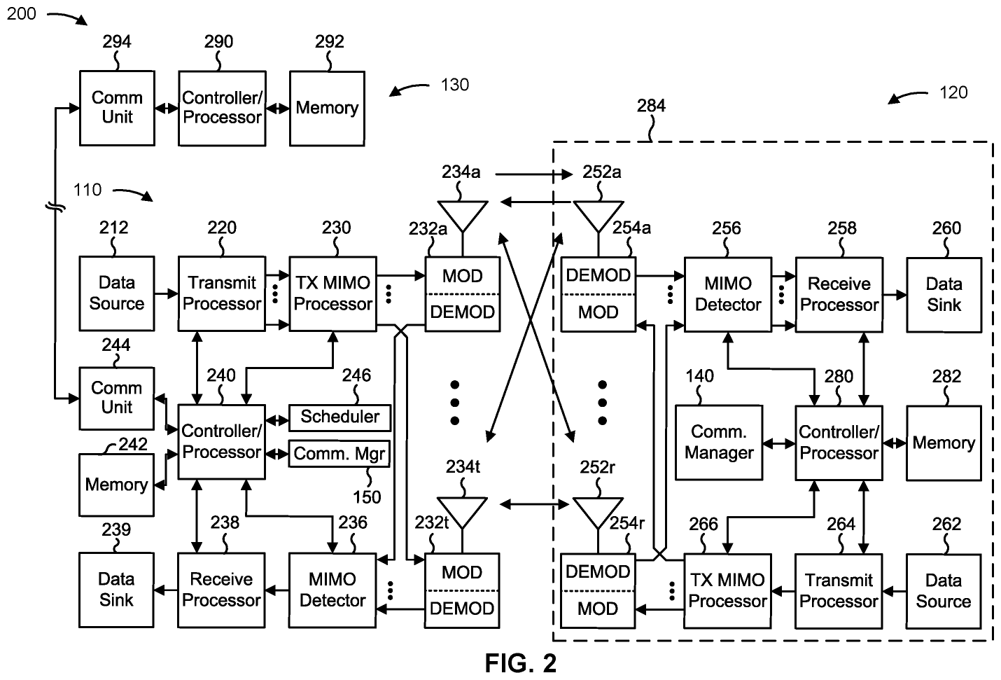

FIG. 2 is a diagram illustrating an example 200 of a network entity (e.g., base station 110) in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network entity via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

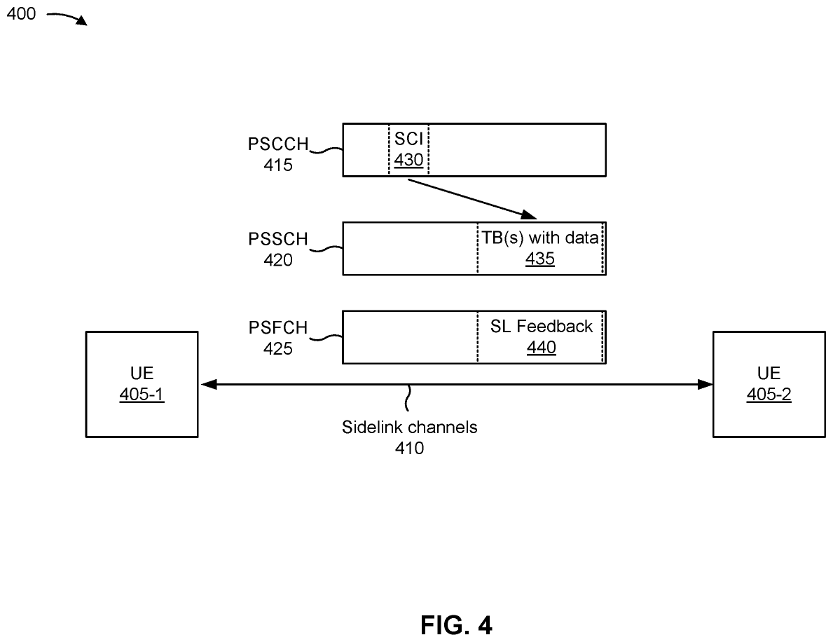

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network entity. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-17).

At the network entity (e.g., base station 110), the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network entity may include a communication unit 244 and may communicate with the network controller 130 via the communication unit 244. The network entity may include a scheduler 246 to schedule one or more UEs 120 for downlink and/or uplink communications. In some examples, the modem 232 of the network entity may include a modulator and a demodulator. In some examples, the network entity includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-17).

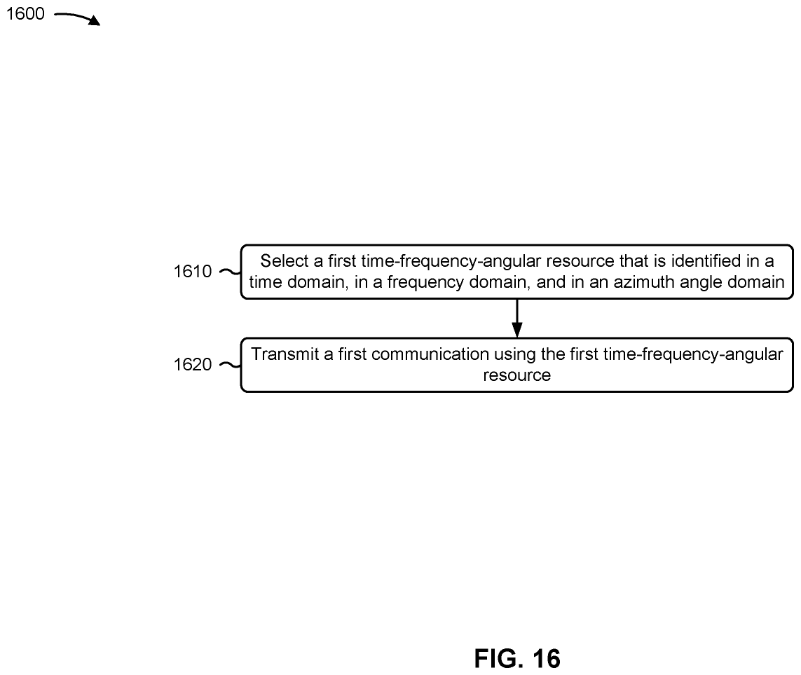

A controller/processor of a network entity (e.g., the controller/processor 240 of the base station 110), the controller/processor 280 of the UE 120, and/or any other component(s) of FIG. 2 may perform one or more techniques associated with time-frequency-angular resources, as described in more detail elsewhere herein. In some aspects, the first device described herein is the UE 120, is included in the UE 120, or includes one or more components of the UE 120 shown in FIG. 2. In some aspects, the first device described herein is a network entity (e.g., the base station 110), is included in the network entity, or includes one or more components of the base station 110 shown in FIG. 2. For example, the controller/processor 240 of the base station 110, the controller/processor 280 of the UE 120, and/or any other component(s) of FIG. 2 may perform or direct operations of, for example, process 1600 of FIG. 16 and/or other processes as described herein. The memory 242 and the memory 282 may store data and program codes for the network entity and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network entity and/or the UE 120, may cause the one or more processors, the UE 120, and/or the network entity to perform or direct operations of, for example, process 1600 of FIG. 16 and/or other processes as described herein. In some examples, executing instructions may include running the instructions, converting the instructions, compiling the instructions, and/or interpreting the instructions, among other examples.

In some aspects, a first device (e.g., a UE 120, network entity) includes means for selecting a first time-frequency-angular resource that is identified in a time domain, in a frequency domain, and in an azimuth angle domain; and/or means for transmitting a first communication using the first time-frequency-angular resource. In some aspects, the means for the first device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the first device to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

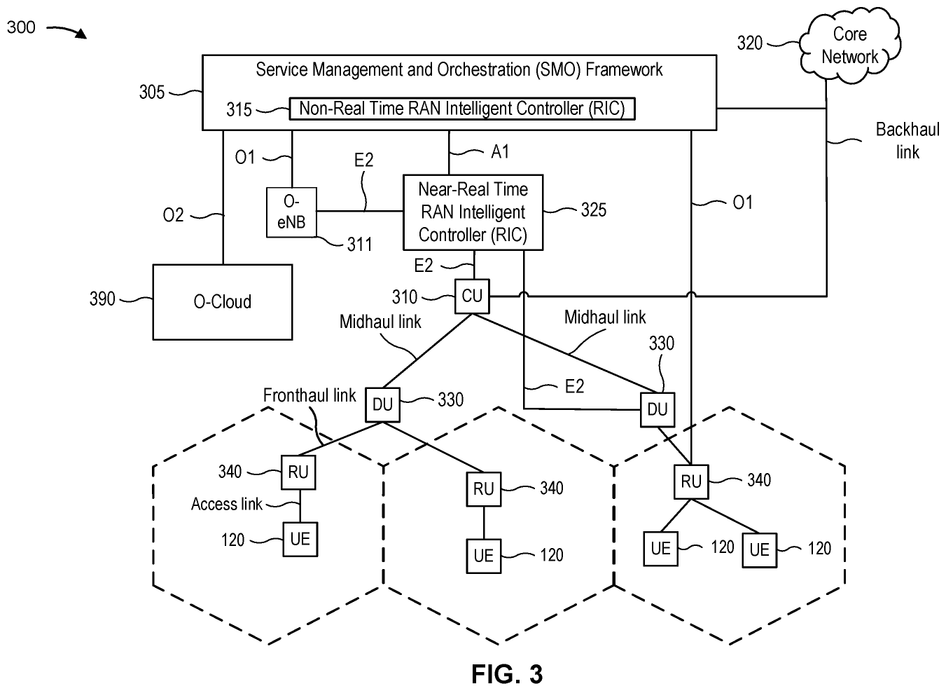

FIG. 3 is a diagram illustrating an example of a disaggregated base station 300, in accordance with the present disclosure.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station, or one or more units (or one or more components) performing base station functionality, may be implemented in an aggregated or disaggregated architecture. For example, a BS (such as a Node B, evolved NB (eNB), NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an JAB network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

The disaggregated base station 300 architecture may include one or more CUs 310 that can communicate directly with a core network 320 via a backhaul link, or indirectly with the core network 320 through one or more disaggregated base station units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The fronthaul link, the midhaul link, and the backhaul link may be generally referred to as “communication links.” The RUs 340 may communicate with respective UEs 120 via one or more RF access links. In some aspects, the UE 120 may be simultaneously served by multiple RUs 340. The DUs 330 and the RUs 340 may also be referred to as “O-RAN DUs (O-DUs”) and “O-RAN RUs (O-RUs)”, respectively. A network entity may include a CU, a DU, an RU, or any combination of CUs, DUs, and RUs. A network entity may include a disaggregated base station or one or more components of the disaggregated base station, such as a CU, a DU, an RU, or any combination of CUs, DUs, and RUs. A network entity may also include one or more of a TRP, a relay station, a passive device, an intelligent reflective surface (IRS), or other components that may provide a network interface for or serve a UE, mobile station, sensor/actuator, or other wireless device.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

FIG. 4 is a diagram illustrating an example 400 of sidelink communications, in accordance with the present disclosure.

As shown in FIG. 4, a first UE 405-1 may communicate with a second UE 405-2 (and one or more other UEs 405) via one or more sidelink channels 410. The UEs 405-1 and 405-2 may communicate using the one or more sidelink channels 410 for P2P communications, D2D communications, V2X communications (e.g., which may include V2V communications, V2I communications, and/or V2P communications) and/or mesh networking. In some aspects, the UEs 405 (e.g., UE 405-1 and/or UE 405-2) may correspond to one or more other UEs described elsewhere herein, such as UE 120. In some aspects, the one or more sidelink channels 410 may use a PC5 interface and/or may operate in a high frequency band (e.g., the 5.9 GHz band). Additionally, or alternatively, the UEs 405 may synchronize timing of transmission time intervals (TTIs) (e.g., frames, subframes, slots, or symbols) using global navigation satellite system (GNSS) timing.

As further shown in FIG. 4, the one or more sidelink channels 410 may include a physical sidelink control channel (PSCCH) 415, a physical sidelink shared channel (PSSCH) 420, and/or a physical sidelink feedback channel (PSFCH) 425. The PSCCH 415 may be used to communicate control information, similar to a physical downlink control channel (PDCCH) and/or a physical uplink control channel (PUCCH) used for cellular communications with a base station 110 via an access link or an access channel. The PSSCH 420 may be used to communicate data, similar to a physical downlink shared channel (PDSCH) and/or a physical uplink shared channel (PUSCH) used for cellular communications with a base station 110 via an access link or an access channel. For example, the PSCCH 415 may carry sidelink control information (SCI) 430, which may indicate various control information used for sidelink communications, such as one or more resources (e.g., time resources, frequency resources, and/or spatial resources) where a transport block (TB) 435 may be carried on the PSSCH 420. The TB 435 may include data. The PSFCH 425 may be used to communicate sidelink feedback 440, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 415, in some aspects, the SCI 430 may include multiple communications in different stages, such as a first stage SCI (SCI-1) and a second stage SCI (SCI-2). The SCI-1 may be transmitted on the PSCCH 415. The SCI-2 may be transmitted on the PSSCH 420. The SCI-1 may include, for example, an indication of one or more resources (e.g., time resources, frequency resources, and/or spatial resources) on the PSSCH 420, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or an MCS. The SCI-2 may include information associated with data transmissions on the PSSCH 420, such as a hybrid automatic repeat request (HARQ) process ID, a new data indicator (NDI), a source identifier, a destination identifier, and/or a channel state information (CSI) report trigger.

In some aspects, the one or more sidelink channels 410 may use resource pools. For example, a scheduling assignment (e.g., included in SCI 430) may be transmitted in sub-channels using specific resource blocks (RBs) across time. In some aspects, data transmissions (e.g., on the PSSCH 420) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 405 may operate using a sidelink transmission mode (e.g., Mode 1) where resource selection and/or scheduling is performed by a base station 110. For example, the UE 405 may receive a grant (e.g., in downlink control information (DCI) or in a radio resource control (RRC) message, such as for configured grants) from the base station 110 for sidelink channel access and/or scheduling. In some aspects, a UE 405 may operate using a transmission mode (e.g., Mode 2) where resource selection and/or scheduling is performed by the UE 405 (e.g., rather than a base station 110). In some aspects, the UE 405 may perform resource selection and/or scheduling by sensing channel availability for transmissions. For example, the UE 405 may measure an RSSI parameter (e.g., a sidelink-RSSI (S-RSSI) parameter) associated with various sidelink channels, may measure an RSRP parameter (e.g., a PSSCH-RSRP parameter) associated with various sidelink channels, and/or may measure an RSRQ parameter (e.g., a PSSCH-RSRQ parameter) associated with various sidelink channels, and may select a channel for transmission of a sidelink communication based at least in part on the measurement(s).

Additionally, or alternatively, the UE 405 may perform resource selection and/or scheduling using SCI 430 received in the PSCCH 415, which may indicate occupied resources and/or channel parameters. Additionally, or alternatively, the UE 405 may perform resource selection and/or scheduling by determining a channel busy ratio (CBR) associated with various sidelink channels, which may be used for rate control (e.g., by indicating a maximum number of resource blocks that the UE 405 can use for a particular set of subframes).

In the transmission mode where resource selection and/or scheduling is performed by a UE 405, the UE 405 may generate sidelink grants, and may transmit the grants in SCI 430. A sidelink grant may indicate, for example, one or more parameters (e.g., transmission parameters) to be used for an upcoming sidelink transmission, such as one or more resource blocks to be used for the upcoming sidelink transmission on the PSSCH 420 (e.g., for TBs 435), one or more subframes to be used for the upcoming sidelink transmission, and/or an MCS to be used for the upcoming sidelink transmission. In some aspects, a UE 405 may generate a sidelink grant that indicates one or more parameters for semi-persistent scheduling (SPS), such as a periodicity of a sidelink transmission. Additionally, or alternatively, the UE 405 may generate a sidelink grant for event-driven scheduling, such as for an on-demand sidelink message.

As indicated above, FIG. 4 is provided as an example. Other examples may differ from what is described with respect to FIG. 4.

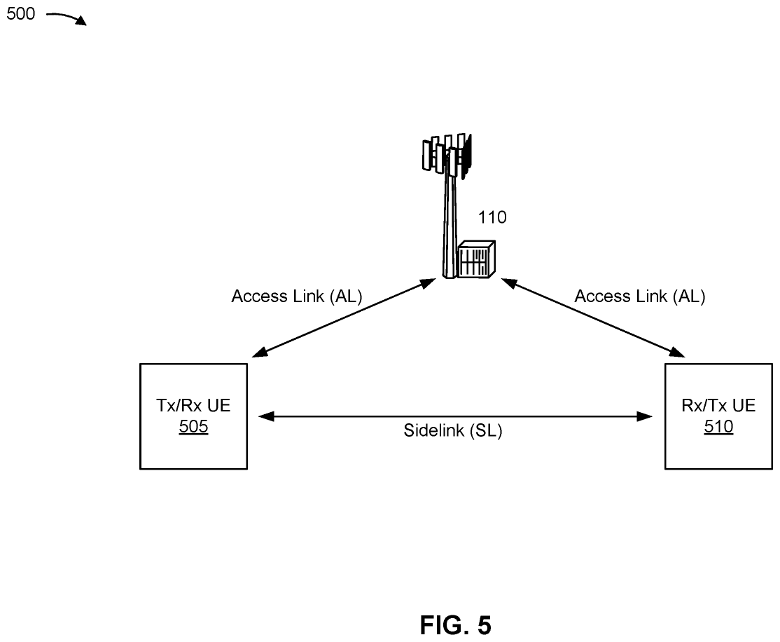

FIG. 5 is a diagram illustrating an example 500 of sidelink communications and access link communications, in accordance with the present disclosure.

As shown in FIG. 5, a transmitter (Tx)/receiver (Rx) UE 505 and an Rx/Tx UE 510 may communicate with one another via a sidelink, as described above in connection with FIG. 4. As further shown, in some sidelink modes, a base station 110 may communicate with the Tx/Rx UE 505 via a first access link. Additionally, or alternatively, in some sidelink modes, the base station 110 may communicate with the Rx/Tx UE 510 via a second access link. The Tx/Rx UE 505 and/or the Rx/Tx UE 510 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 5 is provided as an example. Other examples may differ from what is described with respect to FIG. 5.

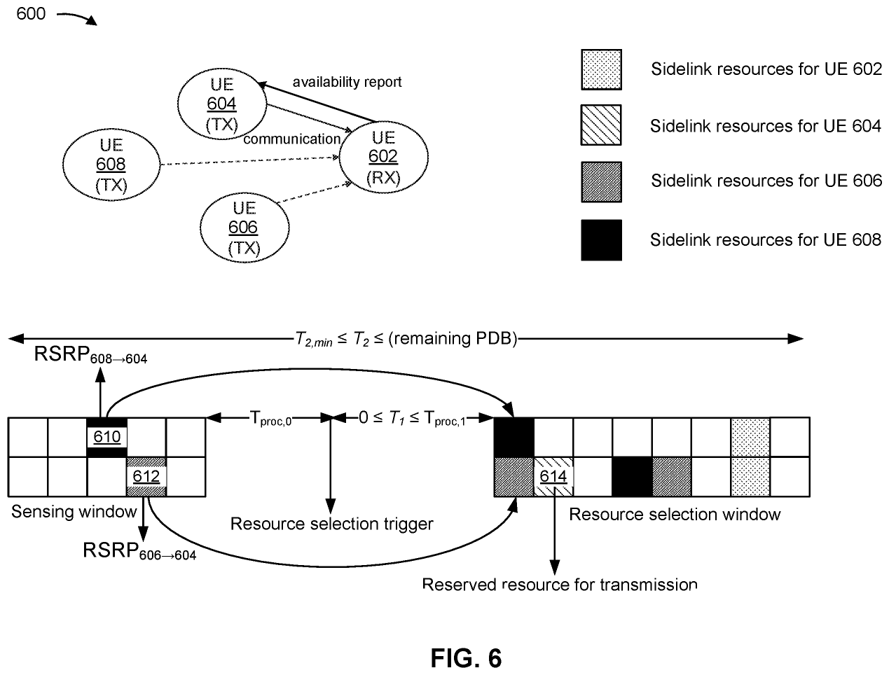

FIG. 6 is a diagram illustrating an example 600 of selecting sidelink resources, in accordance with the present disclosure. Example 600 shows a UE 602 (e.g., a UE 602) that may receive communications on a sidelink channel from other UEs (e.g., a UE 604), such as UE 604, UE 606, and/or UE 608.

As described in connection with FIG. 6, UE 604 is a transmitting UE that is transmitting communications to UE 602, which is a receiving UE. UE 604 may use a report from UE 602, which may act as a reporting UE that reports available sidelink resources, preferred sidelink resources, non-preferred sidelink resources, or sidelink resource conflicts. Example 600 shows an availability report from UE 602 to UE 604 and a communication from UE 604 to UE 602.

If UE 604 is to transmit a communication to UE 602, UE 604 may sense the sidelink channel in a sensing window to determine which sidelink resources (e.g., subcarriers, subchannels) are available. A sidelink resource may be considered available if the sidelink resource was clear or had a signal energy (e.g., RSRP) that satisfied an availability threshold (e.g., measured interference or energy on the channel is lower than a maximum decibel-milliwatts (dBm) or dB, RSRP threshold). The availability threshold may be configured or preconfigured per transmission priority and receive priority pair. UE 604 may measure DMRSs on a PSCCH or a PSSCH, according to a configuration.

For example, UE 604 may prepare to transmit a communication to UE 602. UE 604 may have already sensed previous sidelink resources and successfully decoded SCI from UE 606 and UE 608. UE 604 may try to reserve sidelink resources, and thus may check the availability of the future sidelink resources reserved by UE 606 and UE 608 by sensing the sidelink channel in the sensing window. UE 604 may measure an RSRP of a signal from UE 608 in sidelink resource 610, and an RSRP of a signal from UE 606 in sidelink resource 612. If an observed RSRP (RSRP projection) satisfies the RSRP threshold (e.g., is lower than a maximum RSRP), the corresponding sidelink resource may be available for reservations by UE 604. UE 604 may reserve the sidelink resource (which may be a random selection from available resources). For example, UE 604 may select and reserve sidelink resource 614 for transmission. This may be in a time slot after which UE 606 and UE 608 had used sidelink resources, and UE 604 may have sensed these sidelink resources earlier. UE 604 may select and reserve sidelink resources only upon reaching a threshold level (e.g., 20%, 30%, or 50% availability). UE 604 may increase or decrease the RSRP threshold as necessary to arrive at the threshold level. UE 604 may select and reserve sidelink resources in the current slot and up to two (or more) future slots. Reservations may be aperiodic or periodic (e.g., SCI signals period between 0 ms and 1000 ms). Periodic resource reservation may be disabled.

There may be a resource selection trigger to trigger selection of sidelink resources after a processing time T_{proc,0}, and before another processing time T_{proc,1} before a resource selection window from which sidelink resources are available. The resource selection window may be a time window from which sidelink resources may be selected, and the resource selection window may extend for a remaining packet delay budget (PDB).

UE 604 may be power-sensitive and thus may not afford to continually sense all of the sidelink resources. UE 602 may be more capable of sensing and reporting on the sidelink resources because, for example, UE 602 may be a smart phone while UE 604 may be a smart watch. UE 602 may receive unicast communications from UE 604, and UE 602 may report back available resources to UE 604. UE 602 may continually sense the sidelink resources and measure interference levels involving neighboring UEs. For example, UE 602 may measure an RSRP of a signal from neighboring UE 606 as −92 dBm and an RSRP of a signal from neighboring UE 608 as −102 dBm. For a signal of a last transmission of UE 604, UE 602 measured a target signal level with an RSRP that was −90 dBm. UE 602 may estimate a signal-to-interference ratio (SIR) of a signal between UE 602 and UE 604 as −90−(−92)=2 dB and an SIR between UE 604 and UE 608 as −90−(−102)=12 dB. If the SIR of a signal from UE 604 to UE 602 with interference from UE 608 is large enough (satisfies an availability threshold) for reliable communication between UE 602 and UE 604, UE 602 may mark a sidelink resource that was reserved by UE 608 as available for use for a communication from UE 604 to UE 602. This may be useful when UE 604 has more than one data stream with varying QoS requirements or transmissions with different MCS indices.

UE 602 may transmit a report indicating an availability of each sidelink resource. Rows in the report may represent subcarriers or subchannels, and columns may represent time units (e.g., slots, symbols). The report may be a binary report, such as a bitmap. For example, UE 602 may report a 1 bit for available and a 0 bit for unavailable. UE 604 may decode the report and select (e.g., randomly) N resources from the available sidelink resources for potential N transmissions of a newly generated packet, or a packet of a transport block that has not been transmitted before. UE 604 may select N=4 sidelink resources from the available sidelink resources indicated by the report.

In some aspects, the report may involve different inter-UE coordination schemes that report different information. For example, the report may include information of Type A, which indicates one or more preferred sidelink resources for transmission. The report may include information of Type B, which indicates one or more non-preferred sidelink resources for transmission. The report may include information of Type C, which indicates expected, potential, or detected collisions of one or more sidelink resources. Information of Type A and Type B may be for a first inter-UE coordination scheme, and information of Type C may be for a second inter-UE coordination scheme. The report may involve down-selection in what resources are reported.

As indicated above, FIG. 6 is provided as an example. Other examples may differ from what is described with regard to FIG. 6.

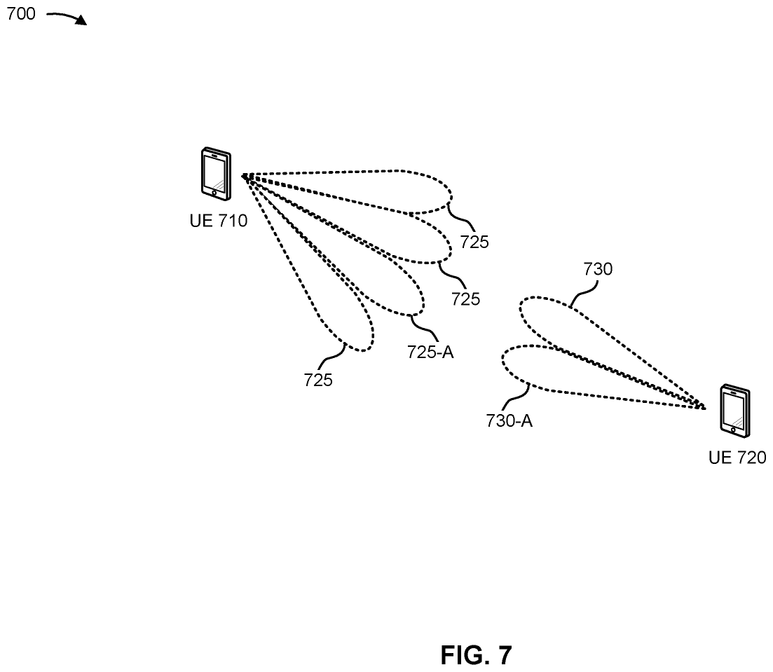

FIG. 7 is a diagram illustrating an example 700 of using beams for communications, in accordance with the present disclosure. As shown in FIG. 7, a UE 710 (e.g., a UE 120) may communicate with another UE 720 (e.g., a UE 120) or a network entity (e.g., a base station 110).

In some scenarios, UE 710 may transmit communications to other UEs, such as UE 720, using a sidelink. UE 710 may be configured for beamformed communications, where UE 710 may transmit in the direction of UE 720 using a directional transmit beam, and UE 720 may receive the transmission using a directional receive beam. Each transmit beam may have an associated beam identifier (ID), a beam direction, or beam symbols, among other examples. UE 710 may transmit sidelink communications via one or more transmit beams 725.

UE 720 may attempt to receive sidelink transmissions via one or more receive beams 730, which may be configured using different beamforming parameters at receive circuitry of the UE 120. UE 720 may identify a particular transmit beam 725, shown as transmit beam 725-A, and a particular UE receive beam 730, shown as UE receive beam 730-A, that provide relatively favorable performance (for example, that have a best channel quality of the different measured combinations of transmit beams 725 and receive beams 730).

As indicated above, FIG. 7 is provided as an example. Other examples may differ from what is described with respect to FIG. 7.

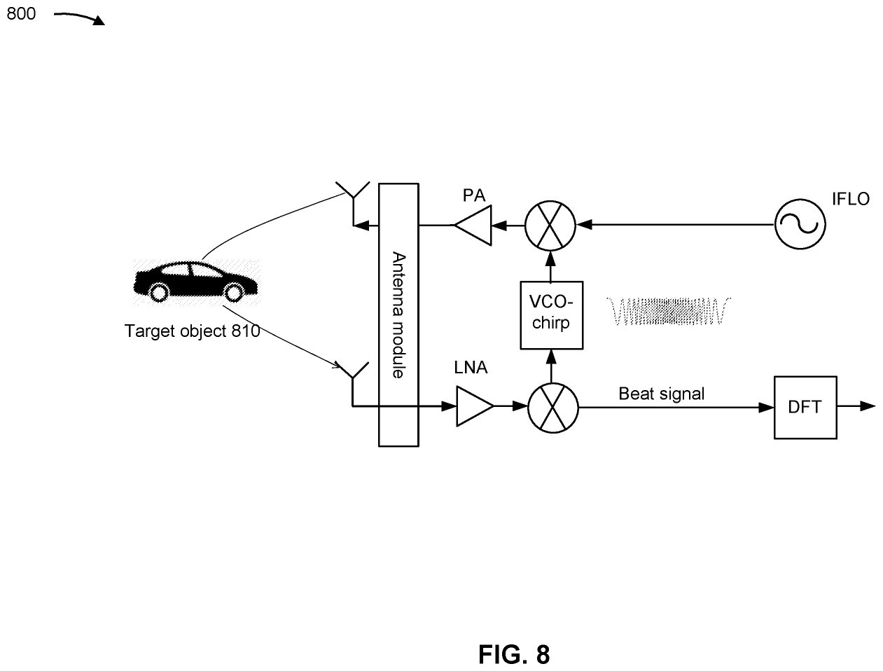

FIG. 8 is a diagram illustrating an example 800 of a radar device, in accordance with the present disclosure.

In some aspects, a radar device may include a radar sensor that radiates a continuous sinusoidal wave that modulates (changes) in operating frequency. The wave may be transmitted over a short interval and referred to as a frequency “chirp signal.” The radar device may generate the chirp signal using an intermediate frequency local oscillator (IFLO) and a voltage-controlled oscillator (VCO) chirp generator. The radar signal (chirp) signal may be amplified with a power amplifier (PA). The radar device may transmit the radar signal and receive a reflected signal that is reflected off of a target object 810 (e.g., vehicle, pedestrian, roadside object) in proximity to the wireless device or vehicle. The radar device may obtain a beat signal from the reflected signal by beating the reflected signal with the locally generated chirp waveform.

In some aspects, a wireless device may be located in a vehicle and may use an OFDM radar (e.g., 5G mmW radio frequency (RF) chain) to detect the target object 810. The OFDM radar may transmit the radar signal and receive a reflected signal that is reflected off of the target object 810.

Radar transmissions require continuous or frequent beam sweeping as well as multiple consecutive slots. These characteristics of radar transmissions impose challenges for communications, such as for sidelink resource management procedures. Radar transmissions can reserve most of the resource pool resources and result in a time-varying spatial interference pattern due to the beam sweeping.

As indicated above, FIG. 8 is provided as an example. Other examples may differ from what is described with regard to FIG. 8.

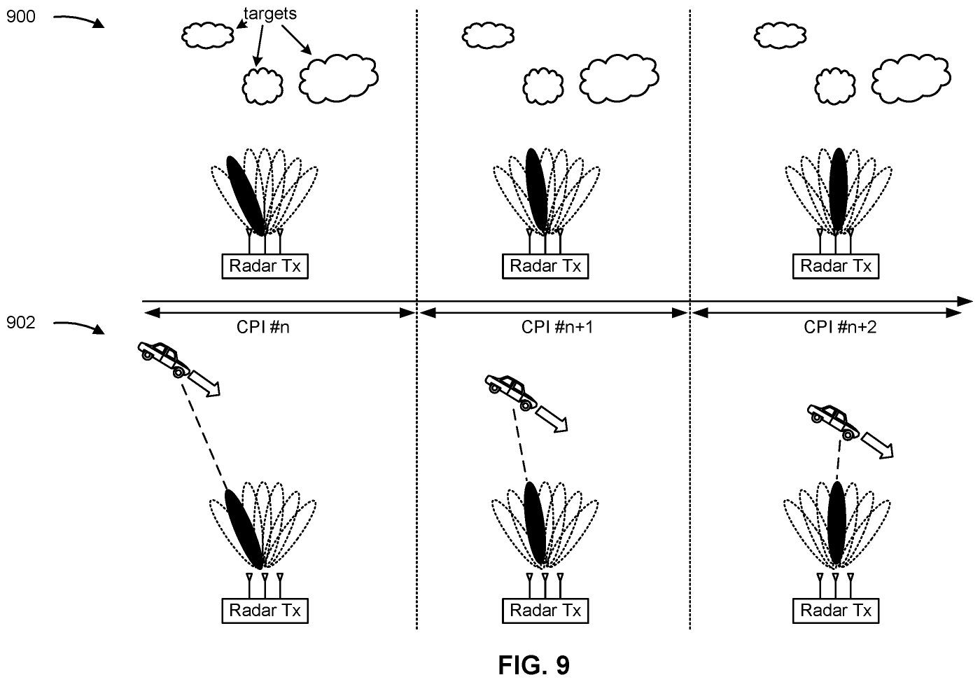

FIG. 9 is a diagram illustrating examples of radar scanning, in accordance with the present disclosure.

Angular position information can be important for sensing applications, especially for sensing applications that involve vehicles. If sensing is performed using transmissions from a single node (i.e., no multi-TRP transmissions to enable triangulation), multi-antenna transmission and reception may be necessary to extract the angular information for target objects. If UEs perform sensing on their own (without assistance), such as for vehicle applications, radar transmissions may necessarily take place over mmWave (or higher) frequencies with multiple antennas. However, radar transmissions in mmWave require frequent or continuous changes of transmit beam direction to achieve sensing over a (wide) angular region and/or to track target objects of interest that are changing angular position due to mobility.

Example 900 shows a radar beam sweep for angular scanning. The beam sweeping may occur over a wide angular range. The time that the beam is active is referred to as a coherent processing interval (CPI). The greater the CPI duration, the greater the detected range (processing gain) and resolution of a target velocity estimate. Note that the CPI is always an integer number of OFDM symbols (at least 1). If all directions are treated equally during the sweep, all beams will have the same CPI.

Example 902 shows a radar has detected a target object of interest and closely tracks the target. The radar beam may follow the target object's movement.

For bandwidth efficiency purposes, radar transmissions are expected to be performed over the same resources as communication transmissions. Therefore, the radar transmissions may be treated as a new source of “traffic” that needs to be accommodated alongside conventional communication traffic. All types of traffic may then be treated the same whether the traffic corresponds to radar transmissions or conventional communication transmissions.

A radar transmission may be allocated time-frequency resources over which it will be performed (using a dynamic or configured grant), so that the radar transmission does not collide or interfere with other transmissions (either for radar or for communication). However, radar transmissions have characteristics that may (or may not) be present in conventional communication transmissions with respect to spatial resource usage. Each radar transmission burst sweeps over multiple beams (especially when performing scanning), with beams changing relatively quickly. On the other hand, a typical communication link is performed over a relatively stable beam. Unless focusing on a specific target or direction, the typical beamwidth of a radar transmission may be much broader than a typical beamwidth of a communication link.

As indicated above, FIG. 9 is provided as an example. Other examples may differ from what is described with regard to FIG. 9.

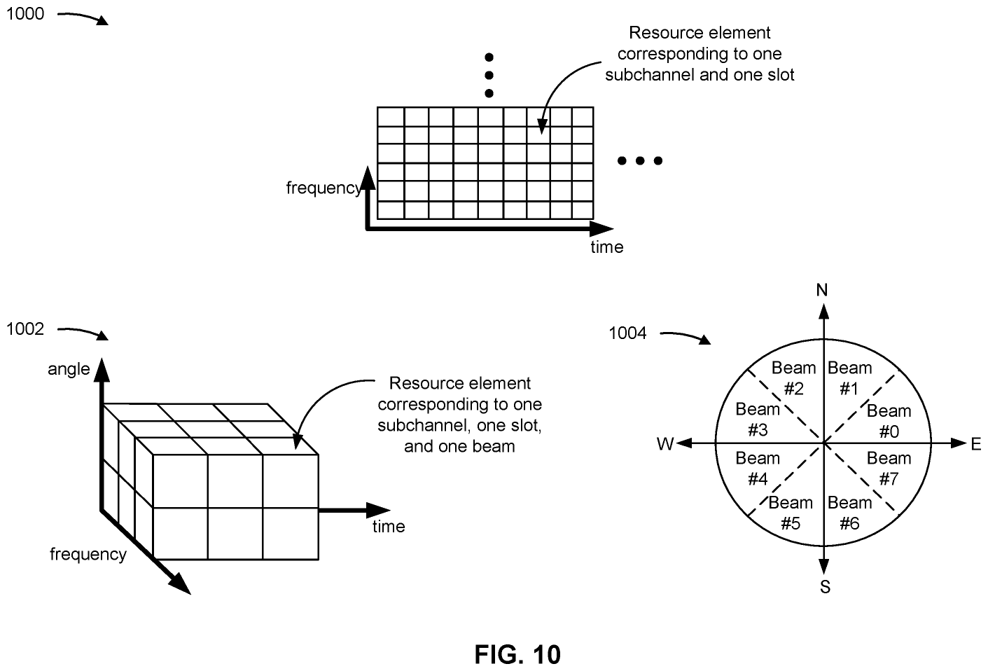

FIG. 10 is a diagram illustrating an example of time-frequency-angular resources, in accordance with the present disclosure.

Example 1000 shows a conventional time-frequency resource pool. Resource elements are allocated in two dimensions (2D), by time and by frequency. For example, a resource element may correspond to one subchannel and one slot. The continuous or frequent beam sweeping of radar transmissions renders conventional interference measurement approaches (e.g., using cross-link interference measurements) unreliable due to the constantly changing spatial interference pattern. This is even more pronounced in vehicular applications where mobility further increases the spatial variability of interference. Current resource management procedures to accommodate radar transmission are not sufficient.

Furthermore, sidelink mode 2 operations are typical for vehicular applications. Sidelink mode 2 resource selection is “beam-agnostic” and relies on transmitting over different time-frequency resources to avoid collisions or interference. However, with the increasing density of radar transmissions and each radar transmission burst requiring a higher bandwidth and more slots than typical cellular V2X (CV2X) transmissions, the time-frequency resources of a resource pool may not be able to support the total amount of traffic.

According to various aspects described herein, a first device (e.g., a UE, a network entity) may use spatial multiplexing as part of three-dimensional (3D) resource allocation. For example, resources may be allocated or reserved for multiple transmissions over the same time-frequency resources but in different beam directions or angles. The first device may allocate, reserve, or be allocated time-frequency-angular resources, which are resources defined in the time domain, the frequency domain, and a spatial (azimuth angle) domain. This angular dimension extends from 0 to 360 degrees and may be partitioned into “beam direction resources” or “beams.” As shown by example 1002, a resource element may correspond to one subchannel, one slot, and one beam. This may result in a 3D resource pool with a fundamental resource allocation unit that is a 3-tuple (subchannel, slot, beam). Each beam may have a beamwidth that is selected to be the same for all of the beams or that is selected to be different per beam. The beam direction values may be absolute in that the beam direction values correspond to directions with respect to a global spatial coordinate system (reference spatial coordinate system) of which all devices (e.g., sidelink UEs) are aware. For example, these directions may correspond to the standard cardinal directions (north, east, south, west).

Example beams 1004 show how the angular dimension may be partitioned into beams. Beam direction values may be specified with reference to a global spatial coordinate system. Each beam may cover a non-zero continuous set of angles (beamwidth). The beamwidth of all beams can be the same (equal) or different. Resource pool beams (directions and beamwidths) may be preconfigured. Example beams 1004 include eight resource beams with each beam having a bandwidth of 45 degrees (360/8=45 degrees). By specifying a beam (angular resource) for a time-frequency-angular-resource, two transmissions over non-overlapping beam resources may occupy the same time-frequency resources.

In some aspects, a resource allocation may be four dimensional (4D) with the addition of a specified elevation angle or altitude as part of a time-frequency-angular-elevation resource. The elevation values may be absolute in that the beam direction values correspond to directions with respect to the global spatial coordinate system.

Without allocating time-frequency-angular resources (or time-frequency-angular-elevation resources), it would be difficult for a UE to understand the spatial interference footprint of each time-frequency resource by simply using measurements. There may be sensing errors for such measurements. For example, a beam direction that is sensed as idle by a transmitting UE can actually be active at a receiving UE side, depending on the position of the transmitting UE, the receiving UE, and an interfering UE. In addition, a continuous beam sweep of radar transmissions renders interference measurements over a beam direction at one time instance irrelevant to actual activity in a following time instance.

However, by allocating time-frequency-angular-resources, devices may allocate and use resources for mmWave or higher frequency bands while accounting for spatial reuse and complicated time-varying spatial interference patterns.

As indicated above, FIG. 10 is provided as an example. Other examples may differ from what is described with regard to FIG. 10.

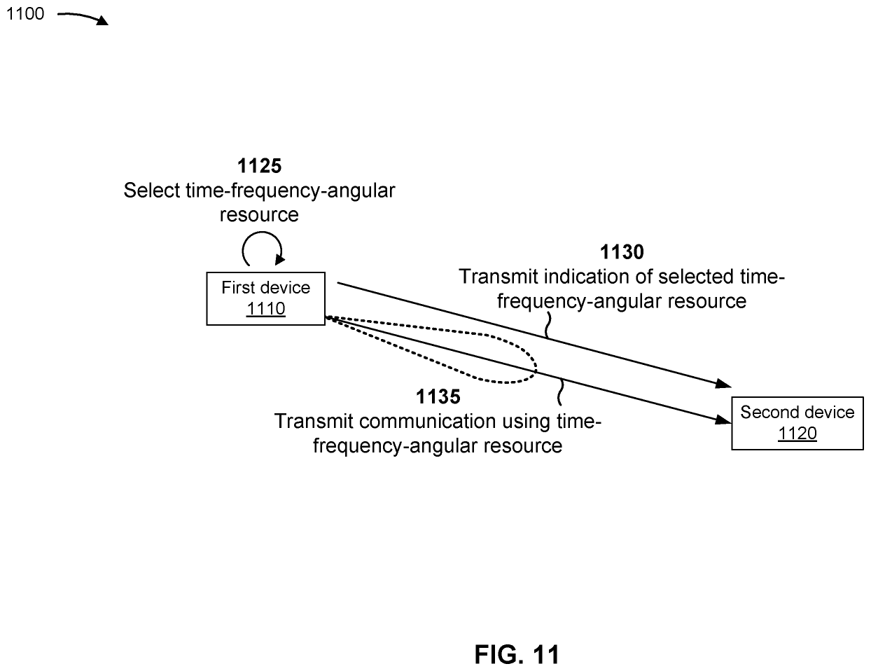

FIG. 11 is a diagram illustrating an example 1100 of using time-frequency-angular resources, in accordance with the present disclosure. As shown in FIG. 11, a first device 1110 (e.g., a UE 120, a UE 405-1, a UE 505, a UE 602, a UE 710, a network entity) and a second device 1120 (e.g., a UE 120, a UE 405-2, a UE 510, a UE 604, a UE 720, a network entity) may communicate with one another.

As shown by reference number 1125, the first device 1110 may select a time-frequency-angular resource that is identified in a time domain, in a frequency domain, and in an azimuth angle domain. If the first device 1110 and the second device 1120 are sidelink UEs, the first device 1110 may select the time-frequency-angular resource after sensing candidate time-frequency-angular resources. Sensing may include obtaining measurements at different frequencies and beam directions. For example, candidate time-frequency-angular resources may be resources that satisfy threshold energy levels (e.g., maximum RSRP) in the frequency domain and the angular domain for being available. A candidate time-frequency-angular resource is available if energy detected for that frequency and azimuth angle does not exceed the threshold energy level. By contrast, a candidate time-frequency-angular resource is not available if the energy detected for that frequency and azimuth angle meets or exceeds the threshold energy level. In some aspects, sensing may also include decoding previous transmissions and checking which resources these transmissions reserve for the future. The latter resources are not to be selected by the first device 1100.

As shown by reference number 1130, the first device 1110 may transmit an indication of the selected time-frequency-angular resource. The time-frequency-angular resource may include a symbol or slot, a subchannel, and a beam. The beam may include a beamwidth in a beam direction of an azimuth angle. In some aspects, the first device 1110 may indicate an elevation angle for the time-frequency-angular resource so as to be a time-frequency-angular-elevation resource. As shown by reference number 1135, the first device 1110 may use the time-frequency-angular resource (or the time-frequency-angular-elevation resource) to transmit a communication. The second device 1120 may use the time-frequency-angular resource (or the time-frequency-angular-elevation resource) for receiving the communication or for transmitting another communication. The communication may include control information or data or may a sensing transmission as part of a radar signal.

In some aspect, if the first device 1110 and the second device 1120 are sidelink UEs, the first device 1110 may transmit reservation information that indicates that the time-frequency-angular resource is reserved by the first device 1110. The reservation information may include, for the time-frequency-angular resource, a tuple that indicates a slot or symbol, a subchannel, and a beam centered at an absolute azimuth angle. The first device 1110 may reserve time-frequency-angular resources in multiple directions of the azimuth angle domain if an absolute transmit beam direction for the transmission is not known by the first device 1110. The first device 1110 may transmit the reservation information in a dedicated resource at multiple azimuth angles or at all of the azimuth angles. The second device 1120 may receive the reservation information and avoid the time-frequency-angular resource for its own transmission based at least in part on the reservation information.

The first device 1110 may also transmit scheduling information that indicates the time-frequency-angular resources scheduled by the first device for sidelink communication. The second device 1120 may receive the scheduling information and select the time-frequency-angular resource for receiving the sidelink communication (or avoid the time-frequency-angular resource for its own transmission) based at least in part on the scheduling information.

The reservation information may include a frequency resource allocation indication value (FRIV), a time RIV (TRIV), and a beam RIV (BRIV). The BRIV may be part of SCI, such as SCI-1, SCI-2, or a backward-compatible SCI-3. Whenever a PSCCH is decoded, the slot and start subchannel of the current transmission time interval (TTI) PSSCH transmission (resource) may be immediately deduced. The slot and start subchannel may match the slot and start subchannel of the decoded PSCCH. For directive transmissions, decoding PSCCH over one beam resource implicitly suggests that the associated PSSCH will be transmitted over the same resource pool beam. However, additional resource pool beams may also be used for the same transmission and thus the additional resource pool beam are to be explicitly indicated by the BRIV. For example, a sidelink pool may contain N_{beams}^{SL} preconfigured beams (angular resources). A single sidelink transmission may span L_{beams} consecutive beams (N_{beams}^{SL}≥L_{beams}≥1), with starting beam n_{beams}^{start} being (0≤n_{beams}^{start}≤N_{beams}^{SL}−L_{beams}−1). BRIV may be equal to n_{beams}^{start}+Σᵢ₌₁^{L}^{_{beams}}⁻¹(N_{beams}^{SL}+1−i), where i is an index of each beam. This BRIV formula may be extended to indicate start angular resource(s) of future transmission(s). Future transmissions may use the same quantity of angular resources as the current transmissions. This may be analogous to how FRIV indicates start subchannel(s) of future resources. BRIV may be used for reserving future transmission angular resources rather than indicating current angular resources since a receiving device that is not matched to the transmit beamwidth may have no time to align angular resources within the current TTI.

In some aspects, the BRIV may be used for radar transmission beam scanning. Similar to time-frequency resource selection, future selected resources may have an arbitrary starting angular resource (beam direction). BRIV field overhead should be large enough to accommodate various configurations. BRIV may be large due to a resource pool containing many angular resources, radar transmissions reserving multiple consecutive slots, and beam sweeping.

To reduce BRIV overhead, the first device 1110 may perform radar sensing over a (wide) angular region with the same (fixed) beam sweeping pattern (unless circumstances dictate otherwise, such as when tracking a specific target). Thus, the BRIV can simply indicate a preconfigured pattern instead of explicitly identifying the angular resources for each future reservation. The pattern may correspond to a row of a preconfigured look-up table (LUT). The LUT may be indexed with beam patterns. For example, for index 0, the beam pattern in the LUT may include the beam directions {0, 1, 2, 3, 4, 5, . . . }. For index 1, the beam pattern in the LUT may include the beam directions {0+1, 2+3, 3+4, 4+5, . . . }. The notation x+y may mean that the first device 1110 uses two angular resources for each transmission (slot) (beam directions x and y) to accommodate a broad beam. For index 2, the beam pattern in the LUT may include the beam directions {0+1, 1+2, 2+3, 3+4, 4+5, . . . } and so forth. The first device 1110 may transmit or receive start information (e.g., starting angular resource) for beam sweeping or other beam sweeping information (e.g., beam sweep pattern of angular resources).

In some aspects, the BRIV could, for example, encode information such as: a pattern (LUT row 2); optionally indicate a pattern start element (e.g., beam direction 2); optionally indicate a quantity of TTIs per beam (e.g., 3 slots); and/or optionally indicate a quantity of TTIs left for the current beam, including the current TTI (e.g., 2 TTIs). In other words, in this example, the beam sweeping pattern of the second row is used, each beam is used for 3 consecutive TTIs (e.g., slots), the current TTI transmission is performed using the 2nd beam in the pattern, and there are two TTIs left (including the current TTI) before switching to the next beam of the pattern.

By using 3D resource pools, for sidelink mode 2, the spatial multiplexing of the angular resources may improve the tracking of spatial interference activity, which is very challenging using current procedures and with radar transmissions operating over the same resources. The 3D resource pools may also enable more efficient resource utilization in sidelink mode 2 operating in FR2 and higher frequencies, which can accommodate new types of traffic envisioned for 6G, such as radar sensing traffic.

As indicated above, FIG. 11 is provided as an example. Other examples may differ from what is described with respect to FIG. 11.

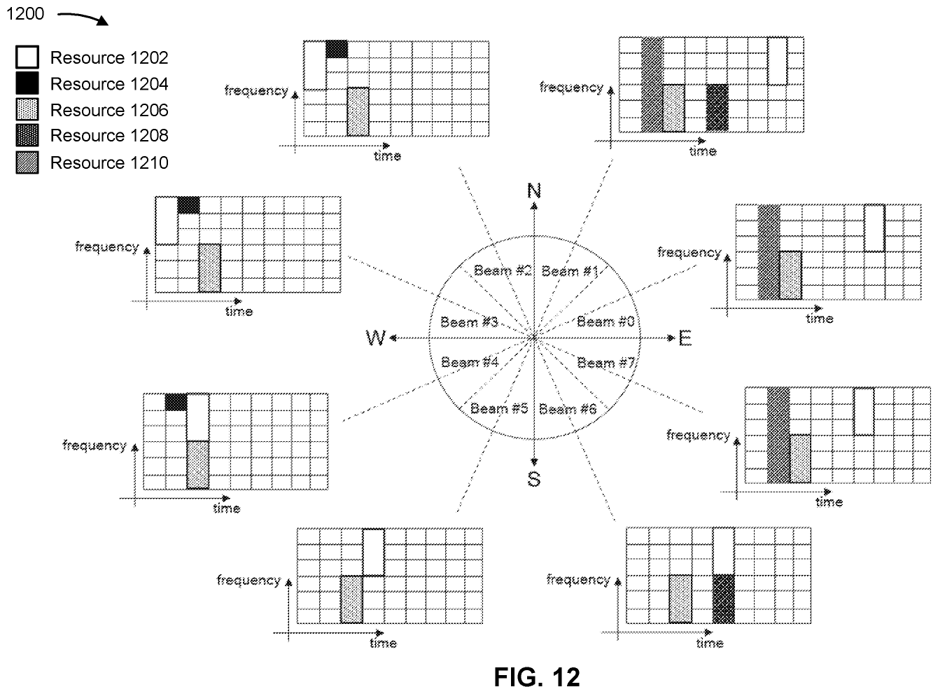

FIG. 12 is a diagram illustrating an example 1200 of time-frequency-angular resources, in accordance with the present disclosure.

Example 1200 shows that some time-frequency resources may overlap if the angular resource is different (different beam). For example, time-frequency resource 1202 remains the same for beam #2 and beam #3; time-frequency resource 1204 remains the same for beam #2, beam #3, and beam #4; time-frequency resource 1206 remains the same for all beams (beam #0-beam #7); time-frequency resource 1208 remains the same for beam #1 and beam #6; and time-frequency resource 1210 remains the same for beam #0, beam #1, and beam #7. However, because of the spatial multiplexing, the time-frequency-angular resources for these beams do not overlap. In fact, none of the time-frequency-angular resources in example 1200 overlap. Time-frequency resource 1210 may be a single slot transmission with a broad beam spanning three angular resources. The first device 1110 may use time-frequency resource 1206 to transmit in an omnidirectional fashion (all angular resources used). Time-frequency resource 1002 may be a radar transmission that sequentially sweeps over all beam directions and thus involves a different time resource for each beam.

As indicated above, FIG. 12 is provided as an example. Other examples may differ from what is described with regard to FIG. 12.

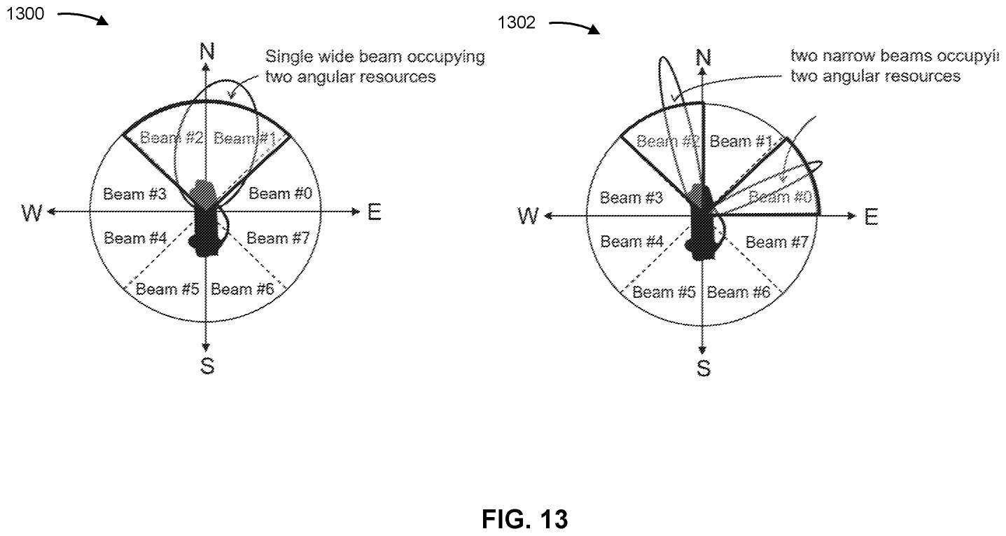

FIG. 13 is a diagram illustrating examples of angular resources, in accordance with the present disclosure.

In some aspects, a transmission may occupy more than one angular resource (beam direction). Example 1300 shows a transmit beamwidth that is too large to be contained within a single resource pool beam direction and spans two consecutive beam directions. A beamwidth can also span more than two beam directions (not necessarily adjacent or contiguous). Example 1302 shows two transmit beams in different beam directions with narrower beamwidths. A transmit beam may be considered to be contained within a set of angular resources when one or more criteria are satisfied, such as if the X-dB beamwidth of the transmission is contained within the angular resources (e.g., X=10) and/or if the effective isotropic radiated power (EIRP) of the beam that is not contained within the directions covered by the angular resources is less than a threshold amount (e.g., minimum RSRP).

In some aspects, a transmit beam may have a beamwidth that does not span a whole angular resource, and a transmit beam may use only the angular resources that cover its beamwidth. Accordingly, there may be some inefficiencies involved within using spatial resources. These inefficiencies may be mitigated by a resource pool configuration with many dense (narrow) angular resources. In some aspects, the first device 1110 may transmit more than one narrow beam using only a single angular resource if the single angular resource is wide enough to contain them all.

Accordingly, in some aspects, a time-frequency-angular resource may identify, in the azimuth angle domain, a beamwidth in a beam direction of an azimuth angle. The first device 1110 may transmit or receive the first communication using a beam, in the beam direction, that occupies a threshold amount of the beamwidth, that does not occupy the threshold amount of the beamwidth, or that occupies the threshold amount of multiple beamwidths. The threshold amount may be a specified width, portion, or percentage of the beamwidth.

In some aspects, the first device 1110 may select the time-frequency-angular resource (3D resources) from a time-frequency-angular resource pool (3D resource pool) of time-frequency-angular resources. The 3D resource pool may be for sidelink mode 1, sidelink mode 2, or an access link. The first device 1110 may transmit or receive 3D resource pool information. The 3D resource pool may also be selectively enabled. 3D resources may be enabled based on a geographical area. For example, a vehicle may operate a 3D resource pool only within certain areas or in areas that are preconfigured. 3D resources may also be enabled by the network or a network configuration that specifies how and/or when 3D resources are to be used. For example, a network entity may enable 3D resources for devices via RRC signaling. The first device 1110 may request 3D resources from the network, or the network may periodically broadcast an indication whether to use 3D resources.

As indicated above, FIG. 13 is provided as an example. Other examples may differ from what is described with regard to FIG. 13.

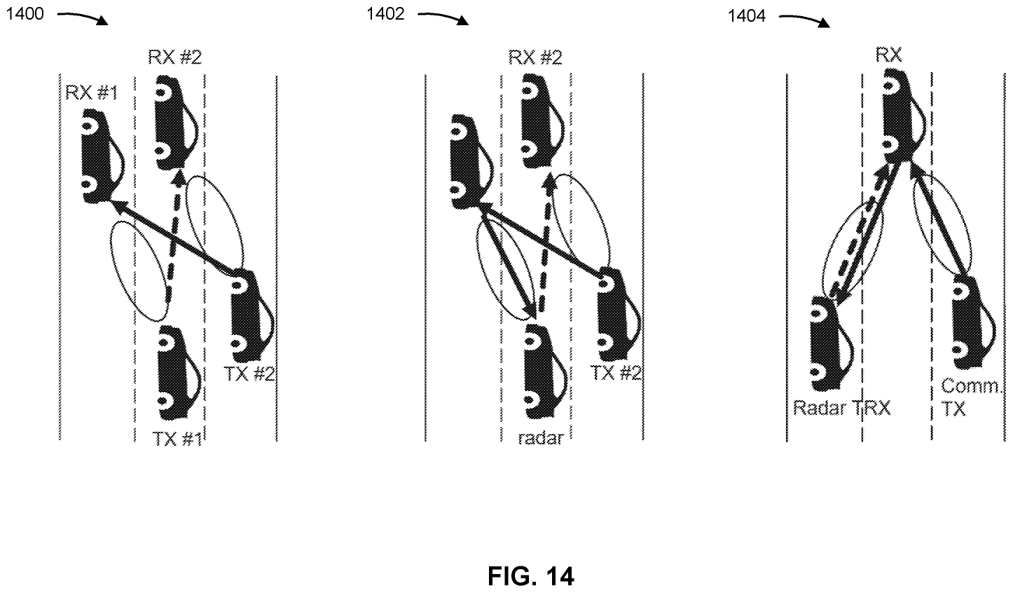

FIG. 14 is a diagram illustrating an example 1400 of resource exclusion, in accordance with the present disclosure.

3D resources that are reserved should be excluded from the resource pool of any device that does resource selection for its own transmission. In this way, transmissions over the same time-frequency-angular resources are avoided, which may avoid interference for communication links and radar sensing operation. Example 1400 shows two communication links over the same 3D resources. RX #1 has a communication link with TX #2 but experiences interference from TX #1. Example 1402 shows a communication link established over the same angular resource as a radar transmission. The communication RX #2 will experience interference from the radar transmission, and the radar sensing will experience interference due to the (bi-static) reflections of the communication TX.

In some scenarios, interference may even occur between transmissions performed over different angular resources (if the time-frequency resources are the same). Example 1404 shows a radar transmission and a communication transmission on the same time-frequency resources but different angular resources, resulting in interference due to the node positions. The radar beam points to the communication link receiver, and the communication beam results in bi-static reflections that will interfere at the radar receiver. Although these configurations may occur infrequently (aided by the random selection of time-frequency resources), the first device 1110 may use some additional conditions to exclude angular resources that are not explicitly reserved. For example, the first device 1110 may exclude resources with beam direction(s) that “intersect” with the direction(s) of reserved transmissions of the second device 1120 or other devices. This may require knowledge of the position of the other device, which may be obtained, for example, by a zone ID in SCI-2 (groupcast) or as part of a base safety message (BSM). In some aspects, the first device 1110 may use a first time-frequency-angular resource that overlaps with a second time-frequency-angular resource in one or two of the time domain, the frequency domain, or the azimuth angle domain. The first device 1110 may select a first time-frequency-angular resource that does not intersect in a beam direction with a second time-frequency-angular resource reserved by the second device 1120.

In some aspects, resource exclusion may involve prioritizing time division multiple access (TDMA) and frequency division multiple access (FDMA) over spatial division multiple access (SDMA). This may minimize interference experienced by two SDMA transmissions over different angular resources (and potentially the same time-frequency resources). For example, let N denote the available 3D resources in the resource pool that the first device 1110 can select from to accommodate its transmission. Out of these N resources, N_{t-f}≤N may denote the resources whose time-frequency components have not been reserved by any other device in any angular resource.

$$If \frac{{N}_{t - f}}{N} >$$

threshold, then the first device 1110 may select the 3D resource out of these N_{t-f} resources.

In some aspects, the first device 1110 may select a time-frequency-angular resource by prioritizing time-frequency resources that are available in the time domain, the frequency domain, and the azimuth angle domain. This may include prioritizing time-frequency resources that have all corresponding time-frequency-angular resources available. For example, given two time-frequency resources T1-F1 and T2-F2, if there are only two angle resources in a resource pool (e.g., A1 and A2), the resource pool may contain the 3D resources T1-F1-A1, T1-F1-A2, T2-F2-A1, and T2-F2-A2 (in addition to other time-frequency-resource tuples). Out of these resources, only T1-F1-A1 has been reserved by another device, leaving the other three resources available for selection. If prioritization of time-frequency resources is applied, the first device 1110 may prioritize the resources T2-F2-A1 and T2-F2-A2 over T1-F1-A2, because the T1-F1 pair has been reserved with some angle (A1), whereas the pair T2-F2 has all beams available.

As indicated above, FIG. 14 is provided as an example. Other examples may differ from what is described with regard to FIG. 14.

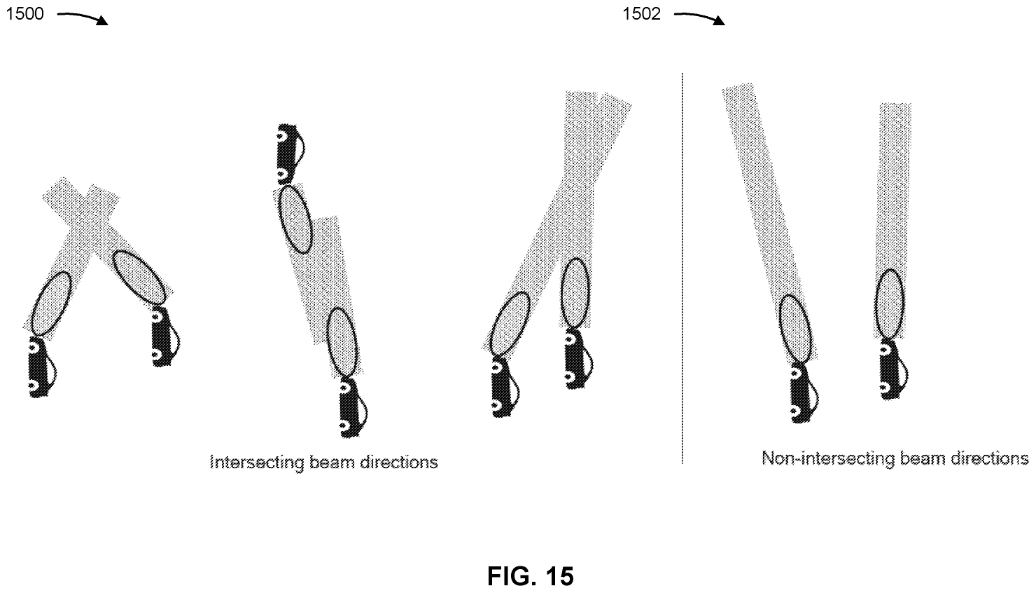

FIG. 15 is a diagram illustrating an example 1500 of intersecting and non-intersecting beam directions, in accordance with the present disclosure.

The beam directions of a first transmitter can “intersect” the beam direction of a second transmitter. The intersection may occur if a semi-line, of a width equal to the beamwidth and extending indefinitely in a beam direction, of the first transmitter intersects a corresponding semi-line of the second transmitter. Example 1500 shows examples of intersecting semi-lines or beam directions. Example 1502 shows examples of non-intersecting semi-lines or beam directions.

In some aspects, 3D resource selection may be performed with the expectation that the first device 1110 device knows the absolute direction of each transmit beam. If the absolute direction of each transmit beam is not known, the first device 1110 may select or reserve all angular resources (as if performing an omni-directional transmission). This may ensure that the transmission will not experience interference, although there may be a cost for reserving all angular resources for transmission. Reserving all angular resources may help to achieve backwards compatibility, in that legacy reservations (not aware of angular resources) may be interpreted by other devices as omni-directional transmissions.

Angular resources of omni-directional reservations may be candidates for preemption. If sensing indicates that certain angular resources are not actually used by the device that reserved them, other devices may preempt these resources. To aid preemption, the first device 1110 may indicate, in SCI, that transmissions are declared as omni-directional due to an unknown transmit beam direction. This indication may enable devices that can sense angular reserved resources as free to preempt the reserved resources if needed. An omni-directional transmission without this indication may be treated as an actual omni-direction transmission and there will be no attempt to preempt the corresponding angular resources.

In some aspects, resource reservations indicated in SCI and transmitted over the same narrow beam as the PSSCH may result in devices missing the reservation if the devices are not located within the beam's field of view. To avoid this situation, in some aspects, the first device 1110 may transmit reservation information (PSCCH) in a separate (dedicated) transmission or slot (preceding the PSSCH transmission or slot) in all directions. To avoid path losses in mmWave transmission, the first device 1110 may transmit the reservation information over an FR1 band. This may cause sidelink UEs to track two bands at the same time.

As indicated above, FIG. 15 is provided as an example. Other examples may differ from what is described with regard to FIG. 15.

FIG. 16 is a diagram illustrating an example process 1600 performed, for example, by a first device, in accordance with the present disclosure. Example process 1600 is an example where the first device (e.g., first device 1110) performs operations associated with using, reserving, and/or allocating time-frequency-angular resources.

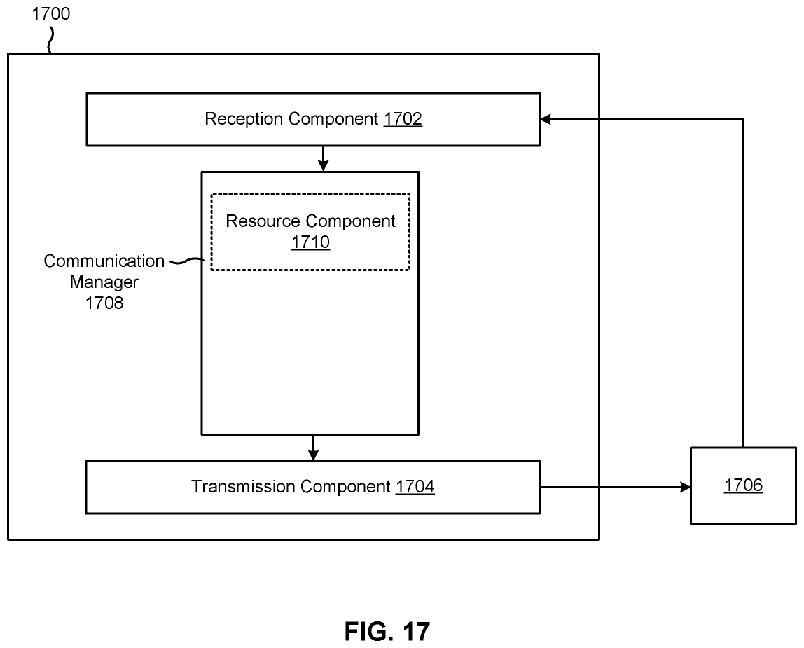

As shown in FIG. 16, in some aspects, process 1600 may include selecting a first time-frequency-angular resource that is identified in a time domain, in a frequency domain, and in an azimuth angle domain (block 1610). For example, the first device (e.g., using communication manager 1708 and/or resource component 1710 depicted in FIG. 17) may select a first time-frequency-angular resource that is identified in a time domain, in a frequency domain, and in an azimuth angle domain, as described above.

As further shown in FIG. 16, in some aspects, process 1600 may include transmitting a first communication using the first time-frequency-angular resource (block 1620). For example, the first device (e.g., using communication manager 1708 and/or transmission component 1704 depicted in FIG. 17) may transmit a first communication using the first time-frequency-angular resource, as described above.

Process 1600 may include additional aspects, such as any single aspect or any combination of aspects described below and/or in connection with one or more other processes described elsewhere herein.

In a first aspect, process 1600 includes sensing candidate time-frequency-angular resources.

In a second aspect, alone or in combination with the first aspect, process 1600 includes transmitting reservation information that indicates time-frequency-angular resources reserved by the first device for sidelink communication.

In a third aspect, alone or in combination with one or more of the first and second aspects, the reservation information includes, for each reserved time-frequency-angular resource, a tuple that indicates a slot or symbol, a subchannel, and a beam centered at an absolute azimuth angle.

In a fourth aspect, alone or in combination with one or more of the first through third aspects, transmitting the reservation information includes transmitting the reservation information in a dedicated resource at multiple azimuth angles.

In a fifth aspect, alone or in combination with one or more of the first through fourth aspects, process 1600 includes reserving time-frequency-angular resources in multiple directions of the azimuth angle domain in response to a determination that an absolute transmit beam direction for the first communication is not known by the first device.

In a sixth aspect, alone or in combination with one or more of the first through fifth aspects, process 1600 includes receiving reservation information that indicates time-frequency-angular resources reserved by a second device for sidelink communication, where selecting the first time-frequency-angular resource includes selecting the first time-frequency-angular resource based at least in part on the reservation information.

In a seventh aspect, alone or in combination with one or more of the first through sixth aspects, process 1600 includes transmitting scheduling information that indicates time-frequency-angular resources scheduled by the first device for sidelink communication.

In an eighth aspect, alone or in combination with one or more of the first through seventh aspects, process 1600 includes receiving scheduling information that indicates time-frequency-angular resources scheduled by a second device for sidelink communication, where selecting the first time-frequency-angular resource includes selecting the first time-frequency-angular resource based at least in part on the scheduling information.

In a ninth aspect, alone or in combination with one or more of the first through eighth aspects, the time-frequency-angular resource identifies, in the azimuth angle domain, a beamwidth in a beam direction of an azimuth angle.

In a tenth aspect, alone or in combination with one or more of the first through ninth aspects, transmitting or receiving the first communication includes transmitting or receiving the first communication using a beam, in the beam direction, that occupies a threshold amount of the beamwidth.

In an eleventh aspect, alone or in combination with one or more of the first through tenth aspects, transmitting or receiving the first communication includes transmitting or receiving the first communication using a beam, in the beam direction, that does not occupy a threshold amount of the beamwidth.

In a twelfth aspect, alone or in combination with one or more of the first through eleventh aspects, transmitting or receiving the first communication includes transmitting or receiving the first communication using a beam that occupies a threshold amount of multiple beamwidths.

In a thirteenth aspect, alone or in combination with one or more of the first through twelfth aspects, the time-frequency-angular resource further identifies an elevation angle.

In a fourteenth aspect, alone or in combination with one or more of the first through thirteenth aspects, selecting the first time-frequency-angular resource includes selecting the first time-frequency-angular resource from a time-frequency-angular resource pool of time-frequency-angular resources.

In a fifteenth aspect, alone or in combination with one or more of the first through fourteenth aspects, the time-frequency-angular resource pool is a pool of time-frequency-angular resources for sidelink.

In a sixteenth aspect, alone or in combination with one or more of the first through fifteenth aspects, process 1600 includes transmitting or receiving resource pool information that indicates one or more time-frequency-angular resources.

In a seventeenth aspect, alone or in combination with one or more of the first through sixteenth aspects, process 1600 includes transmitting or receiving start information that indicates a starting angular resource for beam sweeping.

In an eighteenth aspect, alone or in combination with one or more of the first through seventeenth aspects, process 1600 includes transmitting or receiving beam sweep information that indicates a beam sweep pattern of angular resources.

In a nineteenth aspect, alone or in combination with one or more of the first through eighteenth aspects, process 1600 includes transmitting or receiving a second communication using a second time-frequency-angular resource that overlaps with the first time-frequency-angular resource in one or two of the time domain, the frequency domain, or the azimuth angle domain.

In a twentieth aspect, alone or in combination with one or more of the first through nineteenth aspects, selecting the first time-frequency-angular resource includes selecting a time-frequency-angular resource that does not intersect in a beam direction with another time-frequency-angular resource reserved by a second device.

In a twenty-first aspect, alone or in combination with one or more of the first through twentieth aspects, selecting the first time-frequency-angular resource includes prioritizing time-frequency resources that are available in the time domain, the frequency domain, and the azimuth angle domain.

In a twenty-second aspect, alone or in combination with one or more of the first through twenty-first aspects, process 1600 includes enabling use of time-frequency-angular resources based at least in part on a geographical area.

In a twenty-third aspect, alone or in combination with one or more of the first through twenty-second aspects, process 1600 includes enabling use of time-frequency-angular resources based at least in part on a network type or a network configuration.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram of an example apparatus 1700 for wireless communication. The apparatus 1700 may be a first device (e.g., a UE 120, network entity), or a first device may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, a base station, network entity, or another wireless communication device) using the reception component 1702 and the transmission component 1704. As further shown, the apparatus 1700 may include the communication manager 1708. The communication manager 1708 may control and/or otherwise manage one or more operations of the reception component 1702 and/or the transmission component 1704. In some aspects, the communication manager 1708 may include one or more antennas, a modem, a controller/processor, a memory, or a combination thereof, of the UE or base station described in connection with FIG. 2. The communication manager 1708 may be, or be similar to, the communication manager 140 or 150 depicted in FIGS. 1 and 2. For example, in some aspects, the communication manager 1708 may be configured to perform one or more of the functions described as being performed by the communication manager 140 or 150. In some aspects, the communication manager 1708 may include the reception component 1702 and/or the transmission component 1704. The communication manager 1708 may include a resource component 1710, among other examples.

In some aspects, the apparatus 1700 may be configured to perform one or more operations described herein in connection with FIGS. 1-15. Additionally, or alternatively, the apparatus 1700 may be configured to perform one or more processes described herein, such as process 1600 of FIG. 16. In some aspects, the apparatus 1700 and/or one or more components shown in FIG. 17 may include one or more components of the first device described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, a modem, a demodulator, a MIMO detector, a receive processor, a controller/processor, a memory, or a combination thereof, of the first device described in connection with FIG. 2.

The transmission component 1704 may transmit communications, such as reference signals, control information, data communications, or a combination thereof, to the apparatus 1706. In some aspects, one or more other components of the apparatus 1700 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modem, a modulator, a transmit MIMO processor, a transmit processor, a controller/processor, a memory, or a combination thereof, of the first device described in connection with FIG. 2. In some aspects, the transmission component 1704 may be co-located with the reception component 1702 in a transceiver.

The resource component 1710 may select a first time-frequency-angular resource that is identified in a time domain, in a frequency domain, and in an azimuth angle domain. The transmission component 1704 may transmit a first communication using the first time-frequency-angular resource. The resource component 1710 may sense candidate time-frequency-angular resources. The transmission component 1704 may transmit reservation information that indicates time-frequency-angular resources reserved by the first device for sidelink communication.

The resource component 1710 may reserve time-frequency-angular resources in multiple directions of the azimuth angle domain in response to a determination that an absolute transmit beam direction for the first communication is not known by the first device. The reception component 1702 may receive reservation information that indicates time-frequency-angular resources reserved by a second device for sidelink communication, where selecting the first time-frequency-angular resource includes selecting the first time-frequency-angular resource based at least in part on the reservation information.

The transmission component 1704 may transmit scheduling information that indicates time-frequency-angular resources scheduled by the first device for sidelink communication. The reception component 1702 may receive scheduling information that indicates time-frequency-angular resources scheduled by a second device for sidelink communication, where selecting the first time-frequency-angular resource includes selecting the first time-frequency-angular resource based at least in part on the scheduling information.

The transmission component 1704 may transmit or receive resource pool information that indicates one or more time-frequency-angular resources. The transmission component 1704 may transmit or receive start information that indicates a starting angular resource for beam sweeping. The transmission component 1704 may transmit or receive beam sweep information that indicates a beam sweep pattern of angular resources. The transmission component 1704 may transmit or receive a second communication using a second time-frequency-angular resource that overlaps with the first time-frequency-angular resource in one or two of the time domain, the frequency domain, or the azimuth angle domain.

The resource component 1710 may enable use of time-frequency-angular resources based at least in part on a geographical area. The resource component 1710 may enable use of time-frequency-angular resources based at least in part on a network type or a network configuration.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

The following provides an overview of some Aspects of the present disclosure:

Aspect 1: A method of wireless communication performed by a first device, comprising: selecting a first time-frequency-angular resource that is identified in a time domain, in a frequency domain, and in an azimuth angle domain; and transmitting a first communication using the first time-frequency-angular resource.

Aspect 2: The method of Aspect 1, further comprising sensing candidate time-frequency-angular resources.

Aspect 3: The method of Aspect 1 or 2, further comprising transmitting reservation information that indicates time-frequency-angular resources reserved by the first device for sidelink communication.

Aspect 4: The method of Aspect 3, wherein the reservation information includes, for each reserved time-frequency-angular resource, a tuple that indicates a slot or symbol, a subchannel, and a beam centered at an absolute azimuth angle.

Aspect 5: The method of Aspect 3 or 4, wherein transmitting the reservation information includes transmitting the reservation information in a dedicated resource at multiple azimuth angles.

Aspect 6: The method of any of Aspects 1-5, further comprising reserving time-frequency-angular resources in multiple directions of the azimuth angle domain in response to a determination that an absolute transmit beam direction for the first communication is not known by the first device.

Aspect 7: The method of any of Aspects 1-6, further comprising receiving reservation information that indicates time-frequency-angular resources reserved by a second device for sidelink communication, wherein selecting the first time-frequency-angular resource includes selecting the first time-frequency-angular resource based at least in part on the reservation information.

Aspect 8: The method of any of Aspects 1-7, further comprising transmitting scheduling information that indicates time-frequency-angular resources scheduled by the first device for sidelink communication.

Aspect 9: The method of any of Aspects 1-8, further comprising receiving scheduling information that indicates time-frequency-angular resources scheduled by a second device for sidelink communication, wherein selecting the first time-frequency-angular resource includes selecting the first time-frequency-angular resource based at least in part on the scheduling information.

Aspect 10: The method of any of Aspects 1-9, wherein the time-frequency-angular resource identifies, in the azimuth angle domain, a beamwidth in a beam direction of an azimuth angle.

Aspect 11: The method of any of Aspects 1-10, wherein transmitting or receiving the first communication includes transmitting or receiving the first communication using a beam, in the beam direction, that occupies a threshold amount of the beamwidth.

Aspect 12: The method of any of Aspects 1-10, wherein transmitting or receiving the first communication includes transmitting or receiving the first communication using a beam, in the beam direction, that does not occupy a threshold amount of the beamwidth.

Aspect 13: The method of any of Aspects 1-10, wherein transmitting or receiving the first communication includes transmitting or receiving the first communication using a beam that occupies a threshold amount of multiple beamwidths.

Aspect 14: The method of any of Aspects 1-13, wherein the time-frequency-angular resource further identifies an elevation angle.

Aspect 15: The method of any of Aspects 1-14, wherein selecting the first time-frequency-angular resource includes selecting the first time-frequency-angular resource from a time-frequency-angular resource pool of time-frequency-angular resources.

Aspect 16: The method of Aspect 15, wherein the time-frequency-angular resource pool is a pool of time-frequency-angular resources for sidelink.

Aspect 17: The method of any of Aspects 1-16, further comprising transmitting or receiving resource pool information that indicates one or more time-frequency-angular resources.

Aspect 18: The method of any of Aspects 1-17, further comprising transmitting or receiving start information that indicates a starting angular resource for beam sweeping.

Aspect 19: The method of any of Aspects 1-18, further comprising transmitting or receiving beam sweep information that indicates a beam sweep pattern of angular resources.

Aspect 20: The method of any of Aspects 1-19, further comprising transmitting or receiving a second communication using a second time-frequency-angular resource that overlaps with the first time-frequency-angular resource in one or two of the time domain, the frequency domain, or the azimuth angle domain.

Aspect 21: The method of any of Aspects 1-20, wherein selecting the first time-frequency-angular resource includes selecting a time-frequency-angular resource that does not intersect in a beam direction with another time-frequency-angular resource reserved by a second device.

Aspect 22: The method of any of Aspects 1-21, wherein selecting the first time-frequency-angular resource includes prioritizing time-frequency resources that are available in the time domain, the frequency domain, and the azimuth angle domain.

Aspect 23: The method of any of Aspects 1-22, further comprising enabling use of time-frequency-angular resources based at least in part on a geographical area.

Aspect 24: The method of any of Aspects 1-23, further comprising enabling use of time-frequency-angular resources based at least in part on a network type or a network configuration.

Aspect 25: An apparatus for wireless communication at a device, comprising a processor; memory coupled with the processor; and instructions stored in the memory and executable by the processor to cause the apparatus to perform the method of one or more of Aspects 1-24.

Aspect 26: A device for wireless communication, comprising a memory and one or more processors coupled to the memory, the one or more processors configured to perform the method of one or more of Aspects 1-24.

Aspect 27: An apparatus for wireless communication, comprising at least one means for performing the method of one or more of Aspects 1-24.

Aspect 28: A non-transitory computer-readable medium storing code for wireless communication, the code comprising instructions executable by a processor to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A first device for wireless communication, comprising:
a memory; and
one or more processors, coupled to the memory, configured to:
select a first time-frequency-angular resource that is identified in a time domain, in a frequency domain, and in an azimuth angle domain; and
transmit a first communication using the first time-frequency-angular resource.

2. The first device of claim 1, wherein the one or more processors are configured to sense candidate time-frequency-angular resources.

3. The first device of claim 1, wherein the one or more processors are configured to transmit reservation information that indicates time-frequency-angular resources reserved by the first device for sidelink communication.

4. The first device of claim 3, wherein the reservation information includes, for each reserved time-frequency-angular resource, a tuple that indicates a slot or symbol, a subchannel, and a beam centered at an absolute azimuth angle.

5. The first device of claim 3, wherein the one or more processors, to transmit the reservation information, are configured to transmit the reservation information in a dedicated resource at multiple azimuth angles.

6. The first device of claim 1, wherein the one or more processors are configured to reserve time-frequency-angular resources in multiple directions of the azimuth angle domain in response to a determination that an absolute transmit beam direction for the first communication is not known by the first device.

7. The first device of claim 1, wherein the one or more processors are configured to receive reservation information that indicates time-frequency-angular resources reserved by a second device for sidelink communication, wherein the one or more processors, to select the first time-frequency-angular resource, are configured to select the first time-frequency-angular resource based at least in part on the reservation information.

8. The first device of claim 1, wherein the one or more processors are configured to transmit scheduling information that indicates time-frequency-angular resources scheduled by the first device for sidelink communication.

9. The first device of claim 1, wherein the one or more processors are configured to receive scheduling information that indicates time-frequency-angular resources scheduled by a second device for sidelink communication, wherein the one or more processors, to select the first time-frequency-angular resource, are configured to select the first time-frequency-angular resource based at least in part on the scheduling information.

10. The first device of claim 1, wherein the first time-frequency-angular resource identifies, in the azimuth angle domain, a beamwidth in a beam direction of an azimuth angle.

11. The first device of claim 10, wherein the one or more processors, to transmit or receive the first communication, are configured to transmit or receive the first communication using a beam, in the beam direction, that occupies a threshold amount of the beamwidth.

12. The first device of claim 10, wherein the one or more processors, to transmit or receive the first communication, are configured to transmit or receive the first communication using a beam, in the beam direction, that does not occupy a threshold amount of the beamwidth.

13. The first device of claim 10, wherein the one or more processors, to transmit or receive the first communication, are configured to transmit or receive the first communication using a beam that occupies a threshold amount of multiple beamwidths.

14. The first device of claim 1, wherein the first time-frequency-angular resource further identifies an elevation angle.

15. The first device of claim 1, wherein the one or more processors, to select the first time-frequency-angular resource, are configured to select the first time-frequency-angular resource from a time-frequency-angular resource pool of time-frequency-angular resources.

16. The first device of claim 15, wherein the time-frequency-angular resource pool is a pool of time-frequency-angular resources for sidelink.

17. The first device of claim 1, wherein the one or more processors are configured to transmit or receive resource pool information that indicates one or more time-frequency-angular resources.

18. The first device of claim 1, wherein the one or more processors are configured to transmit or receive start information that indicates a starting angular resource for beam sweeping.

19. The first device of claim 1, wherein the one or more processors are configured to transmit or receive beam sweep information that indicates a beam sweep pattern of angular resources.

20. The first device of claim 1, wherein the one or more processors are configured to transmit or receive a second communication using a second time-frequency-angular resource that overlaps with the first time-frequency-angular resource in one or two of the time domain, the frequency domain, or the azimuth angle domain.

21. The first device of claim 1, wherein the one or more processors, to select the first time-frequency-angular resource, are configured to select a time-frequency-angular resource that does not intersect in a beam direction with another time-frequency-angular resource reserved by a second device.

22. The first device of claim 1, wherein the one or more processors, to select the first time-frequency-angular resource, are configured to prioritize time-frequency resources that are available in the time domain, the frequency domain, and the azimuth angle domain.

23. The first device of claim 1, wherein the one or more processors are configured to enable use of time-frequency-angular resources based at least in part on a geographical area.

24. The first device of claim 1, wherein the one or more processors are configured to enable use of time-frequency-angular resources based at least in part on a network type or a network configuration.

25. A method of wireless communication performed by a first device, comprising:
selecting a first time-frequency-angular resource that is identified in a time domain, in a frequency domain, and in an azimuth angle domain; and
transmitting a first communication using the first time-frequency-angular resource.

26. The method of claim 25, further comprising transmitting reservation information that indicates time-frequency-angular resources reserved by the first device for sidelink communication.

27. The method of claim 25, further comprising receiving reservation information that indicates time-frequency-angular resources reserved by a second device for sidelink communication, wherein selecting the first time-frequency-angular resource includes selecting the first time-frequency-angular resource based at least in part on the reservation information.

28. The method of claim 25, wherein the first time-frequency-angular resource further identifies an elevation angle.

29. A non-transitory computer-readable medium storing a set of instructions for wireless communication, the set of instructions comprising:
one or more instructions that, when executed by one or more processors of a first device, cause the first device to:
select a first time-frequency-angular resource that is identified in a time domain, in a frequency domain, and in an azimuth angle domain; and
transmit a first communication using the first time-frequency-angular resource.

30. An apparatus for wireless communication, comprising:
means for selecting a first time-frequency-angular resource that is identified in a time domain, in a frequency domain, and in an azimuth angle domain; and
means for transmitting a first communication using the first time-frequency-angular resource.
